(19) United States
(12) Patent Application Publication
(10) Pub. No.: US 2025/0276496 A1
(43) Pub. Date: Sep. 4, 2025

(54) SEALING APPARATUS AND METHOD

(71) Applicant: SEWTEC AUTOMATION LTD, Wakefield Yorkshire (GB)

(72) Inventors: Gary DAY, Shepley, Huddersfield Yorkshire (GB); Gary ROBINSON, Drighlington, Bradford Yorkshire (GB); Jason CRYER, Darton, Barnsley Yorkshire (GB); Luke WILLIAMS, Chapel Allerton, Leeds Yorkshire (GB); Philip CROWDER, Brockholes, Holmfirth Yorkshire (GB); Luke WADSWORTH, Huddersfield Yorkshire (GB); Michael DANGERFIELD, Wolverhampton West Midlands (GB)

(21) Appl. No.: 18/859,321

(22) PCT Filed: Apr. 25, 2023
(86) PCT No.: PCT/EP2023/060730

§ 371 Date: Oct. 23, 2024

(30) Foreign Application Priority Data
Apr. 26, 2022 (GB) 2206056.0
Dec. 16, 2022 (GB) 2219010.2

(51) Int. Cl. B29C 65/32; B29C 65/00; B29K 67/00; B29L 31/00

(52) U.S. Cl. CPC B29C 65/32; B29C 66/83413; B29C 66/9121; B29C 66/91421; B29K 2067/046; B29L 2031/7128

(57) ABSTRACT

Apparatuses and methods for production of tea bags or coffee bags from web material are disclosed. An apparatus (1) is provided comprising a first roller (10, 60) and a second counterrotating roller (12, 62) arranged to form at least one nip zone therebetween for applying pressure to a sealing region of web material guided through the at least one nip zone. At least one induction heater element (70, 72) is arranged within at least one of the rollers to apply heat generating energy to at least one of the rollers for heating the sealing region of the web material in the at least one nip zone. A heating apparatus within a roller can comprise at least one induction heater element arranged axially relative to the roller so that heat generating energy is applied only to a segment of the roller.

This disclosure relates to apparatuses and methods for sealing streams of film, and more particularly sealing web material using pressure and heat to produce bags for tea or coffee.

Streams of film can be sealed for various purposes. For example, layers of web material can be bonded together by pressure between counter rotating sealing drums for production of pouches or bags of beverage material such as tea or coffee. The pouches can be manufactured by sealing two layers of tissue web together between sealing dyes provided on counter rotating drums.

Heat can be used for the sealing together with the pressure in a nip between the drums. Heat activated agent can be applied on the seam to bond the layers of the web material together. A solution is to heat the material in the nip using infrared heater elements. In industrial processes large quantities of web material can be guided through the nip at a considerable speed. Considerable amounts of energy may need to be used for the generation of heat for such high-speed sealing operation.

According to an aspect, there is provided a heating apparatus for a sealing roller for production of tea bags or coffee bags and comprising sealing surface areas arranged to apply pressure and heat to web material guided into contact with the roller, the heating apparatus comprising an induction heater element configured to extend axially within the roller such that heat generating energy is applied from within the roller to a segment of the roller.

The induction heater element may be configured to apply heat energy from within the roller in a range from a relatively narrow segment of about 10 degrees to a relatively wide segment of about 180 degrees of the roller circumference. In certain applications the segment range can be selected to be between 60 to 120 degrees. In accordance with a yet more specific aspect the segment can be between 80 to 85 degrees of the roller circumference. In accordance with a specific embodiment, the segment is approximately 83 degrees.

The roller can comprise voids between the sealing surface areas, the thickness of the roller material being in the order of at least 10 mm at the thinnest section of the voids.

According to an aspect, there is provided a sealing apparatus for production of tea bags or coffee bags and comprising a first roller and a second counterrotating roller arranged to form at least one nip zone therebetween for applying pressure to a sealing region of web material guided through the at least one nip zone, and at least one induction heater element within the first roller and/or the second roller and arranged to apply heat generating energy to the first roller and/or the second roller for heating the sealing region of the web material in the at least one nip zone.

According to a more specific aspect the at least one induction heater element is arranged to direct the heat generating energy to a nip forming formation of the first roller and/or a nip forming formation of the second roller.

According to an aspect the sealing apparatus comprises at least one heating apparatus comprising an induction heater element configured to extend axially within a roller such that heat generating energy is applied from within the roller to a segment of the roller.

A sealing apparatus may comprise at least one annular induction heater member arranged within the first roller and/or the second roller in alignment with a respective nip forming formation on the circumference of the first roller and/or the second roller for directing heat generating energy to the nip forming formation. At least one induction heater element may comprise an induction heater coil wound such that it is split into distinct annular induction heater members that align with the respective nip forming formations on the roller.

A sealing apparatus may comprise at least one circumferential nip forming formation and at least one non-circumferential nip forming formation on the surface of at least one of the rollers. Heating of the at least one non-circumferential nip forming formation can be arranged through heat from adjacent at least one circumferential nip forming formation. The mass of the non-circumferential nip forming formation may be less than is the mass of the adjacent at least one circumferential nip forming formation. At least one induction heater member may be provided between circumferential nip forming formations.

In accordance with an aspect at least one first induction heater element is arranged in association with the first roller and at least one second induction heater element is arranged in association with the second roller.

At least one induction heater element can be provided for generating heat for a bonding agent on the web material.

A sealing apparatus may comprise a controller and therein connected heat sensor arrangement. The controller can be configured to control generation of heat energy by at least one induction heater element based on information from the heat sensor arrangement.

In accordance with another aspect there is provided a method of sealing web material, the method comprising applying pressure to a sealing region of the web material passing through at least one nip zone formed between a first roller and a counterrotating second roller and applying heat generating energy from at least one induction heater to the first roller and/or the second roller for heating the sealing region of the web material in the at least one nip zone.

The method may comprise directing heat generating energy from the at least one induction heater element to a nip forming formation of the first roller and/or the second roller.

The method may comprise directing heat generating energy to the at least one nip zone by at least one annular and/or lateral induction heater member arranged within the first roller and/or the second roller in alignment with a respective nip forming formation on the circumference of the first roller and/or the second roller.

The method may comprise heating at least one nip forming formation through heat transferred from adjacent at least one another nip forming formation.

The method may comprise heating at least one non-circumferential nip forming formation on the surface through heat generated in at least one circumferential nip forming formation.

The method may comprise producing sealed bags containing tea or coffee material.

The method may comprise heating both rollers by respective induction heater elements.

The method may comprise use of at least axial one induction heater element configured to apply heat generating energy to a segment from within the associated roller. Both rollers can be heated by respective axial induction heater elements within the rollers.

The method may comprise controlling local generation of heat energy by the at least one induction heater element based on information from a heat sensor arrangement.

A computer software product may be used for controlling the operation of at least a part of the herein described heating and/or sealing apparatus and implementing the method.

Some aspects will now be described in further detail, by way of example only, with reference to the following examples and accompanying drawings, in which:

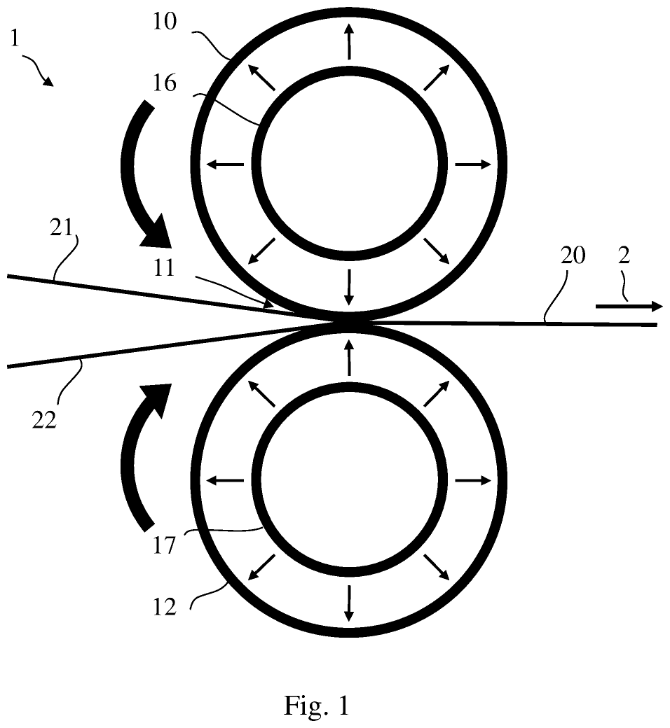

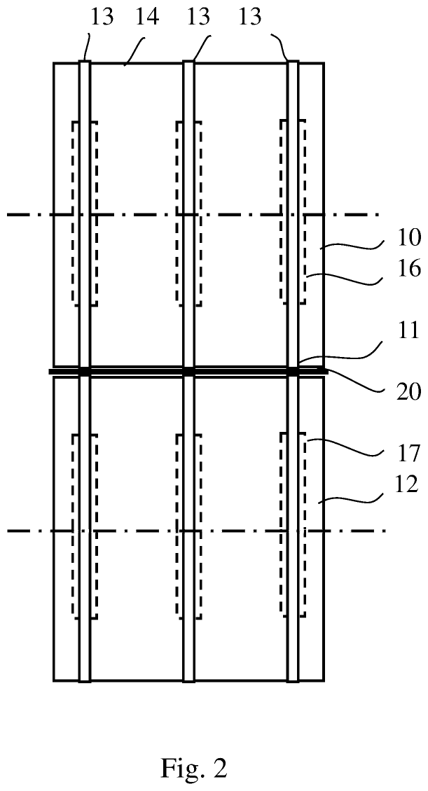

FIGS. 1 and 2 illustrate side and front views of a schematic example of a sealing apparatus;

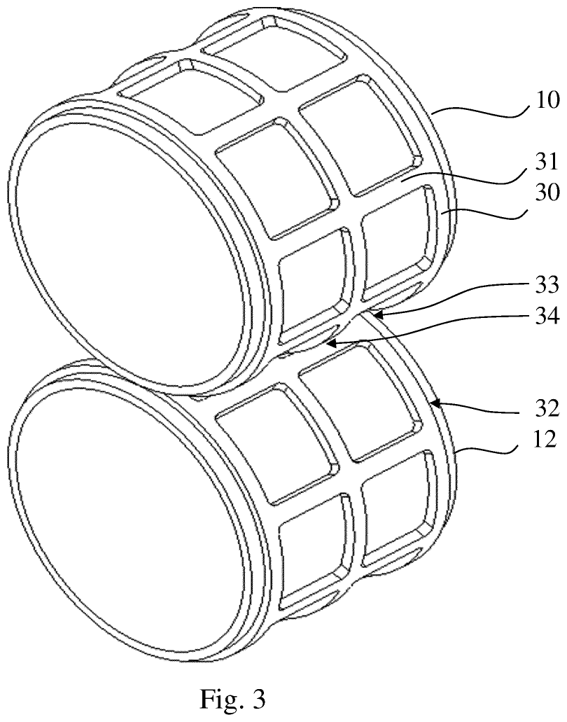

FIG. 3 is a perspective view of another example of sealing rollers;

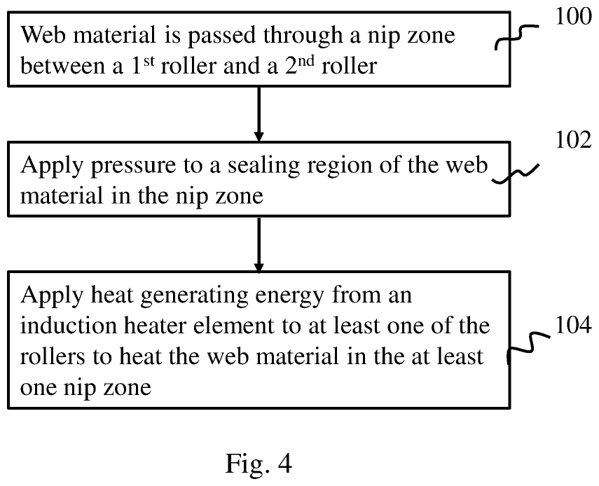

FIG. 4 a flowchart for operation according to an example;

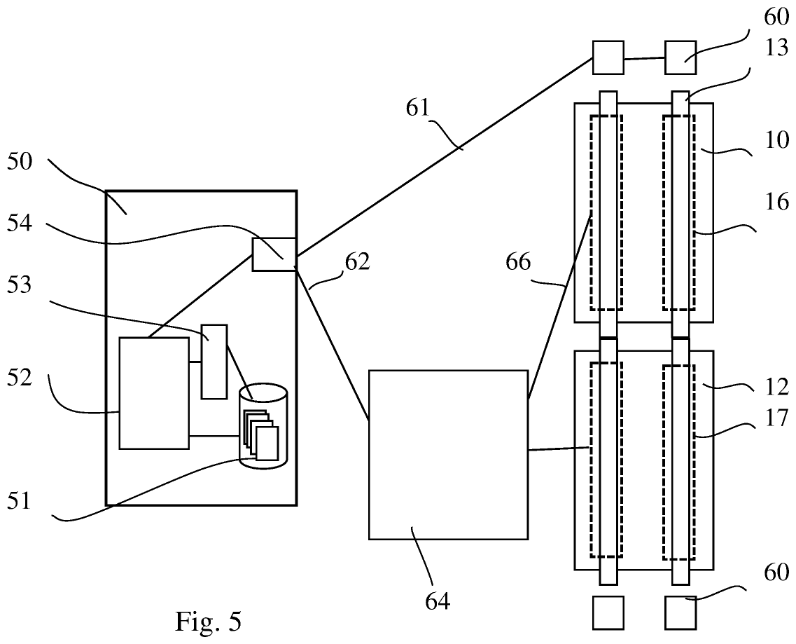

FIG. 5 is an example of a control arrangement;

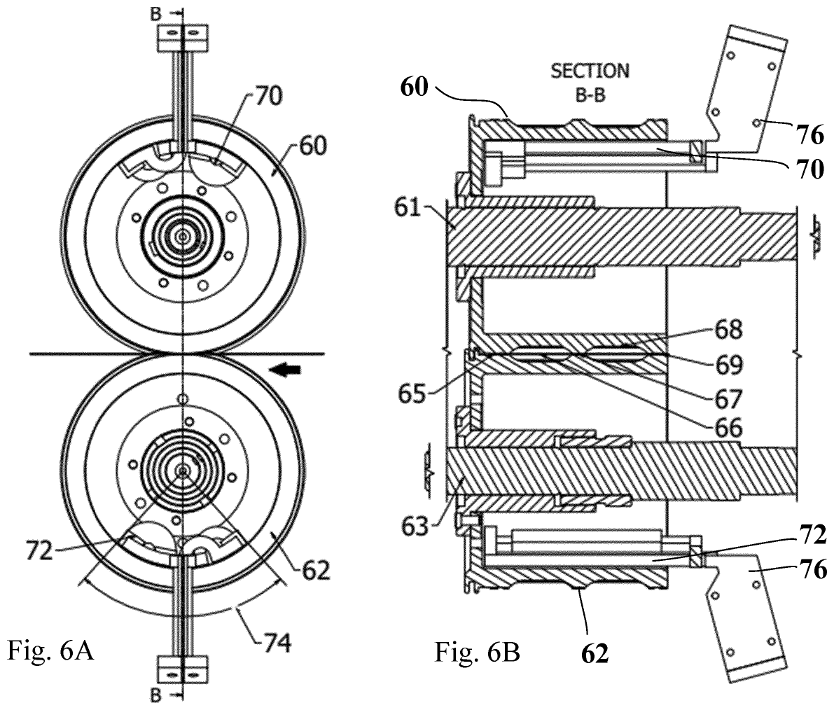

FIGS. 6A and 6B show sectioned views of an arrangement of induction coils within rollers;

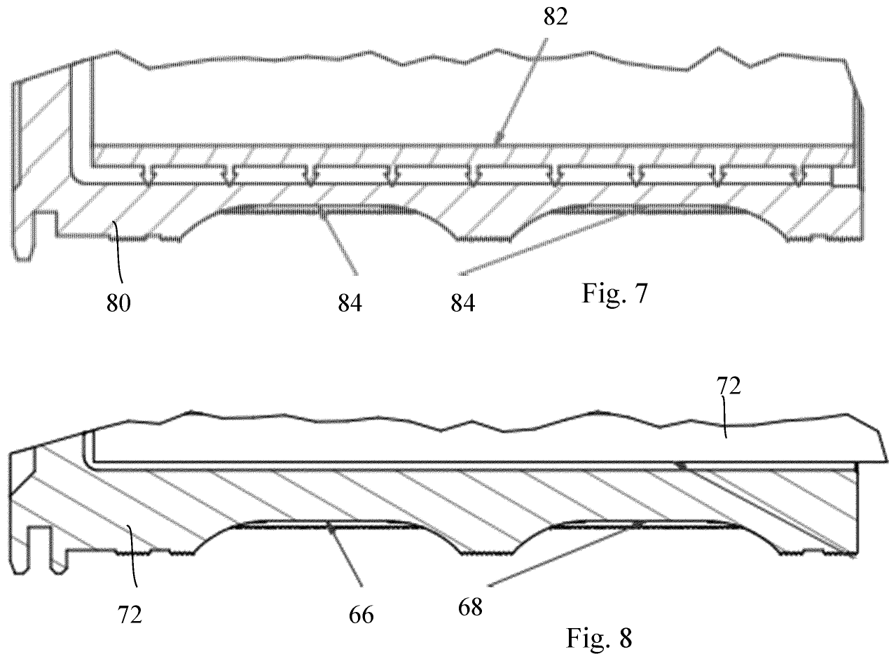

FIG. 7 shows a detail of a conventional central radiant heating arrangement; and

FIG. 8 shows an enlarged detail of the arrangement of FIG. 6B.

The following description gives an exemplifying description of some possibilities to practise the invention. Although the specification may refer to “an”, “one”, or “some” examples or embodiment(s) in several locations of the text, this does not necessarily mean that each reference is made to the same example of embodiment(s), or that a particular feature only applies to a single example or embodiment. Single features of different examples and embodiments may also be combined to provide other embodiments.

FIGS. 1 and 2 are schematic presentations of an apparatus 1 comprising a pair of counterrotating crimp rollers or drums 10, 12 forming weld seaming arrangement comprising narrow nip zones 11 therebetween. The crimp rollers 10, 12 can be made from appropriate material such as steel. The rollers are arranged for pressing together at least two streams of film/web material 21, 22 guided through 10 the nips to form a ply joined film 20. The direction of movement of the web material streams 21, 22 through the nip zone 11 is indicated by arrow 2.

As shown by FIG. 2, the crimp rollers 10, 12 comprise circumferential sealing rims or bands 13 arranged to provide narrow nip zones for pressing the two streams of film 21 and 22 together. In the specific example three narrow nip zones are formed between the rollers by the sealing bands 13 with a larger diameter than is the diameter of the “free” sections 14 of the rollers 10 and 12 between the sealing bands.

In FIG. 2 continuous sealing pressure is generated on the edges and the middle of the web material but other number, location and formation of sealing bands is also possible. It shall be appreciated that that less or more than three nip zones may be provided between a pair of crimp rollers. Also, the sealing does not need to extend only lengthwise along the web material, or lengthwise at all. For example, the rollers may comprise cooperative dye patterns on the drum faces thereof to produce seams extending in desired directions and formations. An example of a dye formation is given in FIG. 3.

The rollers are supported on appropriate bearings mounted on a frame structure and rotated by a drive arrangement. These are well known in the art of rotatable apparatuses and are therefore not shown for clarity.

Heat activated bonding material or sealing membrane can be used for bonding the web material layers 21 and 22 together. The bonding material can be carried to the nip on the material. The bonding material can be provided on both layers of the film. It is also possible to have bonding material on the side of only one of the film layers. An example of bonding agents suitable for sealing tissue web materials such as tea bag material is polyactic acid (PLA).

To activate the bonding agent the rollers 10 and 12 can be provided with induction heater elements arranged to generate heat in the nip zones. FIG. 1 shows induction heater elements comprising annular induction coils 16 and 17. FIG. 2 shows by dashed lines how the induction coil elements 16 and 17 can be arranged inside the roller drums 10, 12 such that the induction coil elements are aligned with the annular sealing bands 13 on the rollers. By such arrangement the heat can be efficiently generated in the sealing bands 13 while energy is not unnecessarily applied to the area of the free zones 14 between the sealing bands.

Heat energy can also be applied from within to the entire drum length and not just at the locations of the sealing bands. This may be the case, for example, when relatively narrow axial induction heating elements (so called ‘hairpin’ elements) are used for the heating. A more detailed example of axially extending induction heating elements is explained later.

The heated sealing bands 13 provide heat in the nip zones 11 to heat bonding agent at the web layers 21, 22 passing through the nip zones.

Induction heating is based on a process where electrically conductive materials like metals are heated by electromagnetic induction using induction coils that create an electromagnetic field within the coil. A feature of the induction heating process is that the heat is generated inside the heated material itself, instead of by an external heat source via heat conduction. Because of this the rollers, and more particularly the sealing bands 13 can be heated rapidly and efficiently at the location of the bands. An induction heater element comprises an electromagnet and an electronic oscillator that passes a high-frequency alternating current (AC) through the electromagnet. The rapidly alternating magnetic field generated by the induction heater element, indicated by the arrows from the coils 16 and 17 in FIG. 1, penetrates the material of the rollers to be heated. The magnetic field generates electric currents (eddy currents) inside the roller material acting as conductor. The eddy currents flow through the resistance of the material and heat it by Joule heating. In ferromagnetic and ferrimagnetic materials, such as iron and steel, heat can also be generated by magnetic hysteresis losses. The frequency of the electric current used for induction heating can be selected depending on the object size, material type, coupling between the induction coil and the object to be heated and penetration depth.

The induction heater elements can be mounted in fixed positions within the rollers and the rollers can rotate around them. For example, the induction heater elements can be mounted on a fixed shaft and the roller can be rotated around the shaft and the elements on an appropriate bearing and drive arrangement. The induction heater elements can also be mounted by a clamping arrangement where brackets extend from within the rollers to external fixing points. Regardless the type of the mounting arrangement, from the point of view of heating efficiency the induction heater element shall be maintained as close as possible relative to the inner wall of the roller drum.

Internal assembly of the induction heater elements provides a compact structure. The assembly is easy to assemble and there is no need for clearance for any heater elements around the rollers. Internally assembled elements are also easier to keep clean from dirt and debris such as fluff from the web material.

The induction coil bands of FIG. 2 can be balanced to achieve optimum heat distribution across the drum face. Heat distribution, along the drum length can be defined by the coil and drum design. Physical intensifiers can be added, at areas where temperature is soaked into the system, to define temperature stability along the entire drum length. The temperature can be control during operation of the apparatus.

In accordance with an example shown in FIG. 5 surface temperature monitoring of the rollers is provided via sensors 60 such as optical pyrometers on each roller 10, 12. The monitoring arrangement provides feedback via link 61 to a controller 50 of the induction heating system adapted to control the coils 16, 17 via its internal electronics and software parameters. This enables quick reaction and adjustment of power supplied via power lines 66 to the induction heater elements by a power unit 64 in response to any detected imbalance.

Two pyrometers may be provided for dual redundancy. If either of the pyrometers detect over-temperature, the system can be stopped. This can be provided to prevent defective sensors from creating out-of-control situations.

One induction coil may be provided per a roller or drum. Each coil can be wound in such a way that it is split into distinct sections or bands that align to the sealing seams 13 on the drums. Such arrangement requires only one input and one return per drum.

An induction heating system or part thereof such as the heater elements, a generator and/or a controller may require a cooling arrangement. Such can be provided, for example, by means of a liquid cooling system. Coolant may be arranged for the induction elements such that the coolant flows directly to the core of and circulates throughout the induction element. An air-cooling system may be used in some applications.

The sealing apparatus can be configured to produce closed bags containing tea or coffee materials. In principle the material to be bagged can be any substance. The bags can contain, for example, one of biomaterial, substance for preparing beverage, food substance, spices, scent, colouring agent, washing powder, medicament or the like. These examples are not an exhaustive list of possible materials.

FIG. 3 shows an example where rollers 10 and 12 comprise cooperative dies 32 for producing sealed bags. Individual bands, on the coil inside the drum, can be positioned where the annular weld seam band is on the sealing roller and the product. In the example bag sealing apparatus the rollers 10, 12 are configured to provide square dies. Heating bands (rings) on the coils are aligned with the annular bands 30 proving the longitudinal seals of the bags (“longitudinal” nip 33). The lateral bands 31 going across the rollers provide a lateral nip 34 for producing the fully sealed bag shape.

The lateral bands 31 between the longitudinal bands 30 can have reduced mass per length compared to the longitudinal bands. This enables arrangement where no direct coil band alignment is necessary for this part of the dye on the drum as sufficient amount of heat transfers from the longitudinal bands to the lateral band for affecting the bonding. Direct induction heating on extended lateral surfaces can be achieved through additional longitudinal induction heater bands at a midpoint of the lateral bands on the surface to be heated.

FIG. 4 shows a flowchart according to an example for a method of sealing web material. In the method web material is passed through at least one nip zone formed between a first roller and a counterrotating second roller at 100. Pressure is applied at 102 to a sealing region of the web material passing through the at least one nip zone. At the same time the sealing region of the web material in the at least one nip zone is heated by application of heat generating energy from inside of at least one roller by at least one induction heater element at 104.

In accordance with an example each roller is provided with at least one induction heater coil.

The heat generating energy can be directed accurately from the at least one induction heater element to a nip forming formation of the first roller and/or the second roller while the surrounding regions are not heated. The heat generating energy can be directed to the at least one nip zone by at least one annular or axial induction heater member arranged within the first roller and/or the second roller. The heating member can be arranged in alignment with a respective nip forming formation of the first roller and/or the second roller. In accordance with a possibility at least one nip forming formation is heated through heat transferred from adjacent at least one another nip forming formation.

The operation of the seaming apparatus, the induction heating elements and any auxiliary devices can be controlled by a control apparatus. An example of such is shown in FIG. 5. The control apparatus 50 can comprise at least one data processor 52, 53 and at least one memory 51 and an interface 54. The control apparatus can control features such as amount of heat applied to the web material, distribution of heat on the sealing bands, machine speed and so on. The power unit 64 controlled via link 62 can feed power to the induction heater elements via the power lines 66 accordingly. The control can be based on information received via link 61 from various sensor equipment, for example heat sensors 60. The induction heater elements are advantageous in providing a fast and accurately reacting control arrangement.

FIG. 6A is a view from one end of a pair of sealing roller drums 60, 62 in accordance with an aspect. FIG. 6B shows a sectional view of the roller drums along the central line B-B of FIG. 6A.

The roller drums 60, 62 are supported by their respective axis 61, 63, and can be moved into and out of engagement with each other. In production, the roller drums are moved together so that the web material is clamped therebetween in a nip between the roller drums and driven by the roller drums through the sealing machine as indicated by the arrow.

Sealing regions or areas 65, 67, 69 are provided for pressing the web material fed into the nip between the rollers. Voids or pockets 66, 68 are provided between the sealing areas. As explained above, the sealing areas are arranged to apply pressure and heat to web material guided into the nip between the rollers to seal the material layers together.

In this example the heating apparatus within a roller comprises an axially extending induction heater element arranged to heat the length of the roller material by applying the heat generating energy from inside. An axial induction heater element 70, 72 can be arranged within each of the roller drums 60, 62. The axial induction heater elements 70, 72 are arranged to extend within the respective rollers such that heat generating energy is applied only to a segment of the roller circumference rather than circumferentially around the entire roller. This is enabled because the induction heater element heats the rotating drum material rather than transfers heat to it, enabling more efficient heating of the roller drum and the sealing areas thereof.

The energy can be applied more accurately to the wall material in a relatively narrow segment 74 of the rotating drum. For example, the induction heater element can be configured to cover and apply heat energy to a relatively narrow ‘hairpin’ segment of about 10 degrees to a relatively wide segment of about 180 degrees of the roller circumference. Depending on the application the segment and heat application range can also be selected to be between 60 to 120 degrees of the circumference. Yet another range suitable for certain applications is 80 to 85 degrees of the roller circumference. In accordance with the specific example of FIG. 6A the segment covered is approximately 83 degrees.

Brackets 76 are provided for fastening the elements 70, 72 within the rollers. The induction heater elements can be held within a clamping arrangement which allows the surface of the active elements to sit close to the inner drum wall. A small clearance between the element and drum surface provides good heating efficiency.

In the example the axial induction heater elements 70, 72 are located at the top and bottom sections of the respective roller drums 60, 61. However, the axial induction heater elements can be positioned, and the heated segments provided differently from the example shown in FIGS. 6A and 6B. For example, an axial induction heater element, or the two induction heater elements can be mounted at the right and/or left sides of the rollers. The induction heater elements can be positioned differently within the pair of roller drums.

FIGS. 6A and 6B show an arrangement where an axial induction heater unit is assembled within each of the rollers. Instead of this more than one axial induction heater unit may be provided within a roller. For example, one unit may be on the left side and another unit on the right side of the roller. This may be used for improved controllability and/or more powerful heat generation. A different number of induction heating units may be provided in the pair of rollers.

The drum walls, and the voids between the sealing areas, can be made thicker than would be possible if radiant heater elements extending circumferentially around the inner surface of the drum were used. This difference is illustrated by FIGS. 7 and 8 showing a sectioned view of the detail of a lower drum 80 and a conventional radiant heating element 82 thereof in FIG. 7 and the lower drum 62 and the axial induction heating element 72 of FIG. 6B in FIG. 8.

The radiant heating element 82 of FIG. 7 extends around the entire internal circumference and effective width of the drum 80 and thus distributes the heat around the entire internal surface of the drum. Such radiant heater element arrangement can however be difficult to control evenly around the entire drum wall area, especially in axial direction. Properties of radiant heater elements limit the wall thickness of the drum. Because of this a commonly used thickness at the bottom region of the pocket 84 is typically in the order of 4 mm. This can cause thermal distortion and hot spots on the drum surface.

The axial induction heater element applies heat energy to a segment of the roller enabling more efficient heating of the roll material. The control of the heat distribution can be made more accurate and a thicker drum wall can be heated evenly to the desired temperature. For example, the thinnest part of the drum 62 at the bottom region of the pockets 66, 68 can be in the order of 10 mm or more. This is found to be sufficient to stabilise the drum thermally.

The herein presented induction coils can be used to accurately heat the sealing drums to provide a controlled seal where the two sealing drums and the material laminate meet at the nip. Additional cartridge heaters may be provided to pre-heat the web material, for example a lower sealing paper. A drum ‘wrap round’ may also be used to pre-heat the web material, for example an upper sealing paper.

In the examples of Figures the induction coils are configured as internal elements to the drums. Different configurations, combinations and assemblies of the heater elements are also possible. For example, the size and/or construction of the rollers may not facilitate use of internal induction heating elements, and at least one induction heating element may be provided externally to the rollers so that heat energy is applied to the drum material from outside.

In accordance with a possibility an induction heater element is arranged to heat only one of the drums.

Nips may be provided by having rims or other outwardly extending formations on the surface of only one of the rollers.

It is noted that although the above detailed examples have been described with reference to certain processes, applications and apparatuses there are several variations and modifications which may be made to the disclosed solution without departing from the scope of the present invention. In particular, the different embodiments have been described as examples. Different features from different embodiments may be combined. The foregoing description provides by way of exemplary and non-limiting examples a full and informative description of exemplary embodiments of the invention. However, various modifications and adaptations may become apparent to those skilled in the relevant arts in view of the foregoing description, when read in conjunction with the accompanying drawings and the appended claims. All such and similar modifications of the teachings of this invention will still fall within the spirit and scope of this invention.

1. A heating apparatus for a sealing roller for production of tea bags or coffee bags and comprising sealing surface areas arranged to apply pressure and heat to web material guided into contact with the roller, the heating apparatus comprising an induction heater element configured to extend axially within the roller such that heat generating energy is applied from inside of the roller to a segment of the roller.

2. The heating apparatus according to claim 1, wherein the induction heater element is configured to apply heat energy to a segment selected from a range of 10 to 180 degrees of the roller circumference.

3. The heating apparatus according to claim 2, wherein the induction heater element is configured to apply heat energy to a segment selected from a range of 60 to 120 degrees of the roller circumference.

4. The heating apparatus according to claim 3, wherein the segment is within the range of approximately 80 to 85 degrees.

5. The heating apparatus according to claim 1, wherein the roller comprises voids between the sealing surface areas, the thickness of the roller material being in the order of at least 10 mm at the thinnest point of the voids.

6. A sealing apparatus for production of tea bags or coffee bags and comprising:
a first roller and a second counterrotating roller arranged to form at least one nip zone therebetween for applying pressure to a sealing region of web material guided through the at least one nip zone, and
at least one induction heater element within the first roller and/or the second roller and arranged to apply heat generating energy to the first roller and/or the second roller for heating the sealing region of the web material in the at least one nip zone.

7. The sealing apparatus of claim 6, wherein the at least one induction heater element is arranged to direct the heat generating energy to a nip forming formation of the first roller and/or the second roller.

8. The sealing apparatus of claim 6, comprising at least one annular induction heater member arranged within the first roller and/or the second roller in alignment with a respective nip forming formation on the circumference of the first roller and/or the second roller for directing heat generating energy to the nip forming formation.

9. The sealing apparatus of claim 8, wherein the at least one induction heater element comprises an induction heater coil wound such that it is split into distinct annular induction heater members that align with the respective nip forming formations on the roller.

10. The sealing apparatus of claim 6, wherein the at least one induction heater element is configured to extend axially within the first roller and/or the second roller such that heat generating energy is applied from inside of the roller to a segment of the roller.

11. The sealing apparatus of claim 6, comprising at least one circumferential nip forming formation and at least one non-circumferential nip forming formation on the surface of at least one of the rollers, wherein heating of the at least one non-circumferential nip forming formation is arranged through heat from adjacent at least one circumferential nip forming formation.

12. The sealing apparatus of claim 11, wherein the mass of the non-circumferential nip forming formation is less than the mass of the adjacent at least one circumferential nip forming formation.

13. The sealing apparatus of claim 11, comprising at least one induction heater member between circumferential nip forming formations.

14. The sealing apparatus of claim 6, wherein at least one induction heater element is arranged within each roller of a pair of rollers forming a sealing nip.

15. The sealing apparatus of claim 6, wherein the at least one induction heater element is provided for generating heat for a bonding agent on the web material.

16. The sealing apparatus of claim 6, comprising a controller and therein connected heat sensor arrangement, wherein the controller is configured to control generation of heat energy by the at least one induction heater element based on information from the heat sensor arrangement.

17. A method of producing tea bags or coffee bags from web material, the method comprising:
applying pressure to a sealing region of the web material passing through at least one nip zone formed between a first roller and a counterrotating second roller, and
applying to the first roller and/or the second roller heat generating energy by at least one induction heater element within the first roller and/or the second roller for heating the sealing region of the web material in the at least one nip zone.

18. The method of claim 17, comprising directing the heat generating energy from the at least one induction heater element to a nip forming formation of the first roller and/or the second roller.

19. The method of claim 17, comprising directing the heat generating energy to the at least one nip zone by at least one annular induction heater member arranged within the first roller and/or the second roller in alignment with a respective nip forming formation on the circumference of the first roller and/or the second roller.

20. The method of claim 17, comprising directing the heat generating energy to a segment of the first roller and/or the second roller by at least one induction heater element arranged axially within the first roller and/or within the second roller.

21. The method of claim 17, comprising heating at least one nip forming formation through heat transferred from adjacent at least one another nip forming formation.

22. The method of claim 17, comprising heating at least one non-circumferential nip forming formation on the surface of the roller through heat generated in at least one circumferential nip forming formation.

23. The method of claim 17, comprising producing sealed bags containing tea or coffee material.

24. The method of claim 17, comprising controlling local generation of heat energy by the at least one induction heater element based on information from a heat sensor arrangement.
